(19) United States
(12) Patent Application Publication
(10) Pub. No.: US 2015/0281826 A1
(43) Pub. Date: Oct. 1, 2015

(54) INFRARED EARPHONE

(71) Applicant: Jetvox Acoustic Corp., Taoyuan (TW)

(72) Inventor: To-Teng HUANG, Taoyuan City (TW)

(21) Appl. No.: 14/614,070

(22) Filed: Feb. 4, 2015

(30) Foreign Application Priority Data
Mar. 26, 2014 (TW) 103205172

(51) Int. Cl. H04R 1/10

(52) U.S. Cl. CPC H04R 1/1041; H04R 1/1075; H04R 1/1008; H04R 2201/028; H04R 2420/03; H04R 2460/03

(57) ABSTRACT

An infrared earphone includes a speaker protecting cover, a speaker, an infrared detecting module and an ear cushion. The speaker protecting cover includes a main body, a recessed portion and a slot. The main body includes a first region and a second region disposed at the periphery of the first region. The recessed portion is disposed at the first region and the inner lateral plane thereof is lower than the surface of the second region. The slot is disposed at the inner lateral plane of the recessed portion. The speaker is disposed at the first region and adjacent to the slot. The infrared detecting module is disposed in the slot and coupled to the speaker. The infrared detecting module includes a controlling unit. The ear cushion is assembled speaker protecting cover.

### CROSS-REFERENCES TO RELATED APPLICATIONS

This non-provisional application claims priority under 35 U.S.C. §119(a) on Patent Application No. 103205172 filed in Taiwan, R.O.C. on 2014 Mar. 26, the entire contents of which are hereby incorporated by reference.

### BACKGROUND

1. Technical Field

The disclosure relates to an earphone, and particularly to an infrared earphone.

2. Related Art

Along with the developments of technology, devices such as portable music players, the Walkman, notebooks and smart phones, all have a music playing function. Additionally, in order to prevent the user from being disturbed by environmental noise or to prevent people nearby being disturbed, earphones are applied to combine with the aforementioned electronic device, so that the user can enjoy the music without disturbance to themselves or others.

The mute function of the conventional earphone is controlled by either the computer connected to the conventional earphone, or the button configured on the conventional earphone. Accordingly, when the user wears the conventional earphone, the user cannot see the mute button and must check the position of the mute button with hands, or must remove the conventional earphone to press the mute button, which is inconvenient for the user.

Additionally, when the user temporary takes off the earphone, music is still released by the earphone; thus, the earphone consuming the electricity meaninglessly.

Therefore, improving the structure of the conventional earphone while considering the operation habit of the user and user convenience, is an urgent matter for person skilled in the art to address.

### SUMMARY

In view of this, the disclosure provides an infrared earphone able to automatically turn the volume thereof on or off, according to the infrared reflection value.

The disclosure provides an infrared earphone configured to be worn on an ear portion of a user. The ear portion includes cochlea. The infrared earphone includes a speaker protecting cover, a speaker, an infrared detecting module and an ear cushion. The speaker protecting cover includes a main body, a recessed portion and a slot. The main body includes a first region and a second region. The second region is disposed at the periphery of the first region. The recessed portion is disposed at the first region. The inner lateral plane of the recessed portion is lower than the surface of the second region. The slot is disposed at the inner lateral plane of the recessed portion. The speaker is disposed at the first region and adjacent to the slot. The infrared detecting module is disposed in the slot and coupled to the speaker. The infrared detecting module includes a controlling unit. The ear cushion is assembled to the speaker protecting cover. A reflection distance is defined between the infrared detecting module and the cochlear of the user. The controlling unit generates an infrared reflection value according to the reflection distance so as to turn on or turn off the speaker according to the infrared reflection value.

As described previously, the infrared detecting module detects whether the infrared earphone is worn on the user or not, and determines whether to turn on or turn off the infrared earphone according to the infrared reflection value; thus the infrared earphone is turned on or turned off automatically.

The detailed features and advantages of the disclosure are described below in great detail through the following embodiments, the content of which is sufficient for those skilled in the art to understand the technical content of the disclosure and to implement the disclosure there accordingly. Based upon the content of the specification, the claims, and the drawings, those skilled in the art can easily understand the relevant objectives and advantages of the disclosure.

### BRIEF DESCRIPTION OF THE DRAWINGS

The disclosure will become more frilly understood from the detailed description given herein below for illustration only and thus not limitative of the disclosure, wherein:

FIG. 1 is a schematic view for showing an infrared earphone of a first embodiment of the disclosure as worn on a user;

FIG. 2 is a perspective view of the infrared earphone of the first embodiment of the disclosure;

FIG. 3 is a perspective view for showing a speaker protecting cover and an ear cushion of the infrared earphone of the first embodiment of the disclosure;

FIG. 4 is an exploded view of the infrared earphone of the first embodiment of the disclosure;

FIG. 5 is another exploded view of the infrared earphone of the first embodiment of the disclosure;

FIG. 6 is a schematic view for showing the speaker protecting cover of the infrared earphone of the first embodiment as worn on an ear portion of the user;

FIG. 7 is a block diagram for showing the infrared earphone and an infrared detecting module thereof of the first embodiment;

FIG. 8 is a schematic view showing the infrared earphone of the first embodiment worn on the user;

FIG. 9 is a schematic view showing the infrared earphone of the first embodiment not worn on the user;

FIG. 10 is a block diagram showing an infrared earphone of a second embodiment and an infrared detecting module thereof;

FIG. 11 is a block diagram showing an infrared earphone of a third embodiment and an infrared detecting module thereof; and

FIG. 12 is a block diagram showing an infrared earphone of a fourth embodiment and an infrared detecting module thereof.

### DETAILED DESCRIPTION

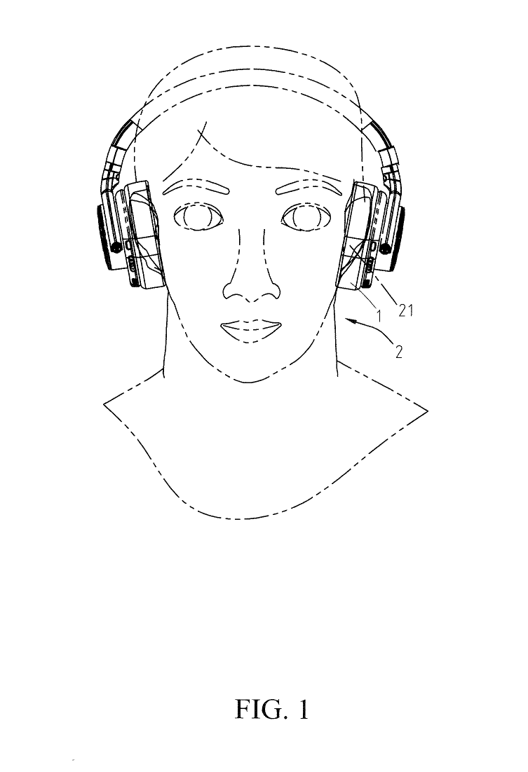

Please refer to FIG. 1, which is a schematic view for showing an infrared earphone 1 as worn on a user. The infrared earphone 1 of the disclosure is provided to wear on the ear portion 21 of the user 2. In this embodiment, the infrared earphone 1 is an ear-cushion type infrared earphone; in some embodiments, the infrared earphone 1 is a canalphone, but embodiments are not limited thereto.

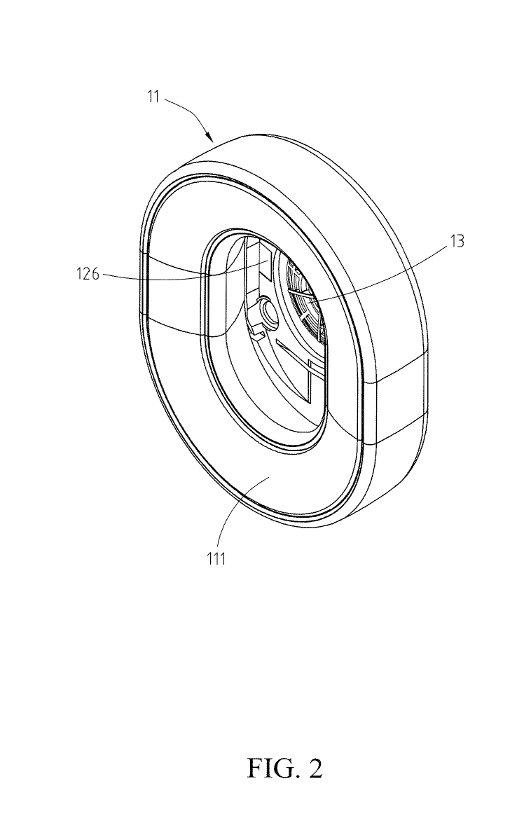

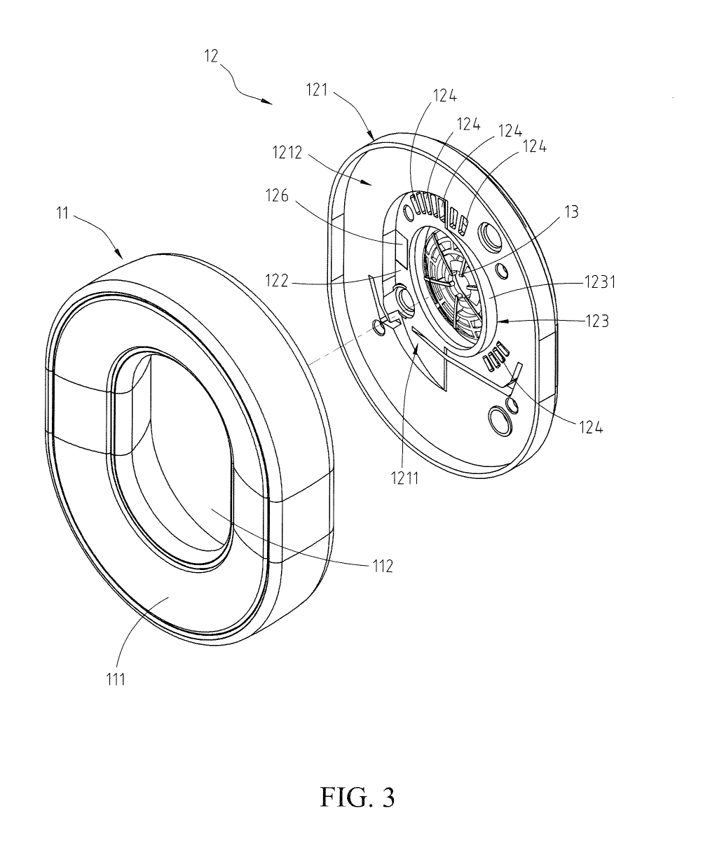

Please refer to FIG. 2 and FIG. 3, in which the infrared earphone I of the first embodiment is illustrated; in which FIG. 2 is a perspective of the infrared earphone 1 of the first embodiment and FIG. 3 is a perspective view showing a speaker protecting cover 12 and an ear cushion 11 of the infrared earphone 1 of the first embodiment. Here, for the sake of convenience, the wearing portion of the infrared earphone 1 is omitted in FIG. 2 and FIG. 3. In this embodiment, the infrared earphone 1 includes the ear cushion 11, the speaker protecting cover 12 and a speaker 13.

The ear cushion 11 is made of soft materials, and the appearance of the ear cushion 11 is ring shaped. The material of the ear cushion 11 is not limited hereto, and can be determined optionally according to the products to make.

In this embodiment, the ear cushion 11 includes an ear-attaching portion 111 and a central portion 112. The ear-attaching portion 111 is disposed around the periphery of the central portion 112 and is provided for attaching on the ear portion 21 of the user 2. Additionally, the surface of the ear-attaching portion 111 is tilted toward the central portion 112, so that an outer periphery of the ear-attaching portion 111 is higher than an inner periphery of the ear-attaching portion 111. Accordingly, when the infrared earphone 1 is worn on the ear portion 21 of the user 2, besides the outer periphery of the ear-attaching portion 111 providing impermeability, the inner periphery of the ear-attaching portion 111 is not attached to the ear portion 21 of the user 2, so that the user wears the infrared earphone 1 comfortably.

The speaker protecting cover 12 is assembled to the ear cushion 11. For example, since the ear cushion 11 is made of soft materials, the ear cushion 11 is combined with the speaker protecting cover 12 using the soft character, but the assembling means between the speaker protecting cover 12 and the ear cushion 11 are not limited thereto.

In this embodiment, the speaker protecting cover 12 includes a main body 121, a recessed portion 122, an assembling portion 123 and a plurality of acoustic output orifices 124. The main body 121 includes a first region 1211 and a second region 1212. The second region 1212 is disposed at a periphery of the first region 1211. The recessed portion 122 is disposed at the first region 1211, and the assembling portion 123 is disposed at the first region 1211. Specifically, an inner lateral plane of the recessed portion 122 is lower than a surface of the second region 1212; that is, the inner lateral plane of the recessed portion 122 is recessed from the surface of the second region 1212.

In this embodiment, the speaker 13 is disposed at a central region of the first region 1211 so as to accomplish a good acoustic output performance without being interfered by the ear-attaching portion 111. Additionally, when the speaker protecting cover 12 is assembled to the ear cushion 11, the ear-attaching portion 111 does not shield the speaker 13 so as to ensure the performance of the acoustic output.

In detail, the speaker 13 is assembled on the assembling portion 123. The assembling portion 123 is, for example, a receiving hole provided for receiving the speaker 13. Furthermore, one of two ends of the assembling portion 123 includes a protruding ring 1231, and the other end of the assembling portion 123 is connected to the recessed portion 122. The protruding ring 1231 is protruded from the surface of the second region 1212, so that the assembling portion 123 is tilted respect to the recessed portion 122.

In this embodiment, the acoustic output orifices 124 are disposed at the periphery of the assembling portion 123 and are provided for the speaker 13 to generate sounds or to adjust tunes. In detail, the positions of the acoustic output orifices 124 do not correspond to the position of the ear-attaching portion 111; for example, the acoustic output orifices 124 can be disposed at the recessed portion 122, or can be disposed at other portions, such as the surface of the second region 1212. Based on this, when the speaker protecting cover 12 is assembled to the ear cushion 11, the ear-attaching portion 111 does not shield the acoustic output orifices 124, thereby achieving good acoustic output performance.

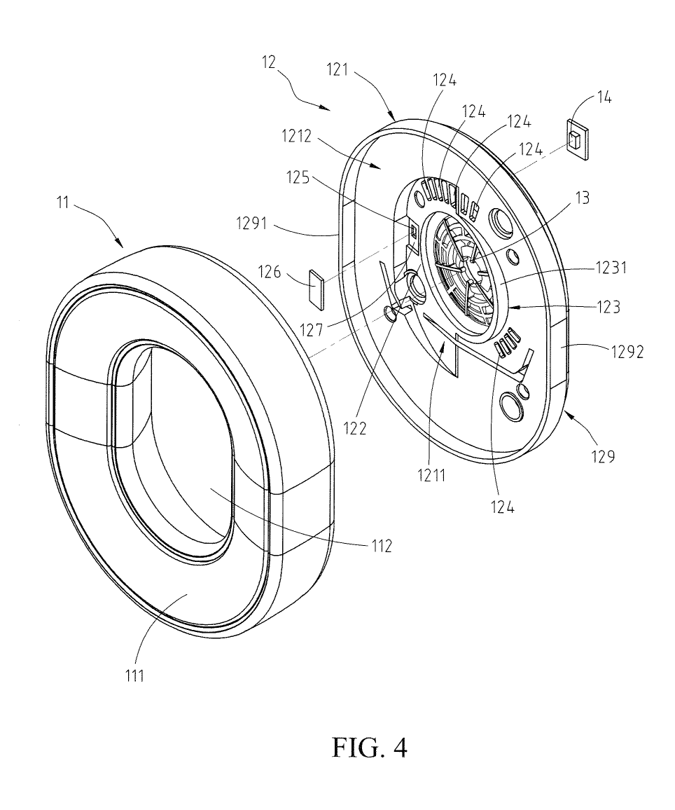

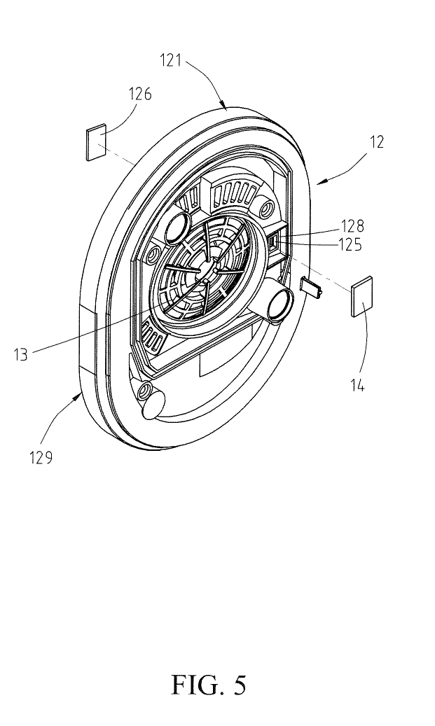

Please refer to FIG. 4 and FIG. 5, in which FIG. 4 is an exploded view of the infrared earphone 1 of the first embodiment and FIG. 5 is another exploded view of the infrared earphone 1 of the first embodiment. In order to clearly illustrate the interior of the infrared earphone 1, the wearing portion of the infrared earphone 1 is omitted in FIG. 4 and FIG. 5, and in FIG. 5, the ear cushion 11 is also omitted. In this embodiment, the infrared earphone 1 further includes an infrared detecting module 14.

The speaker protecting cover 12 further includes a slot 125. In this embodiment, the first region 1211 includes the assembling portion 123, the recessed portion 122 and the slot 125. The slot 125 is disposed at the inner lateral plane of the recessed portion 122, and the speaker 13 is adjacent to the slot 125. That is, the slot 125 is disposed at the first region 1211 and adjacent to the assembling portion 123; the speaker 13 is disposed at the assembling portion 123, so that the speaker 13 is adjacent to the slot 125.

The infrared detecting module 14 is disposed in the slot 125 and coupled to the speaker 13. Furthermore, the infrared detecting module 14 is not shielded by the ear-attaching portion 111 of the ear cushion 11, to ensure efficient detections are provided. The outline of the slot 125 is approximately formed as a rectangle; however, embodiments are not limited thereto, the outline of the slot 125 is matched with the infrared detecting module 14 for assembling with the infrared detecting module 14.

Furthermore, the speaker protecting cover 12 further includes a radio frequency member 126, a first groove 127, a second groove 128 and an outer periphery 129. The radio frequency member 126, the first groove 127 and the second groove 128 are disposed at the first region 1211 of the main body 121. In detail, the first groove 127 is disposed on the surface of the recessed portion 122 and adjacent to the assembling portion 123. The second groove 128 is disposed on the other surface of the recessed portion 122. The slot 125 is passing through and communicates with the first groove 127 and the second groove 128. The slot 125 is approximately disposed on the central portion of the first groove 127 and the second groove 128, and the infrared detecting module 14 is disposed in the slot 125 and adjacent to the assembling portion 123.

The radio frequency member 126 is provided for the infrared earphone 1 as a wireless transmission tool. The radio frequency member 126 is disposed in the first groove 127 and covers the infrared detecting module 14 and the slot 125. The cap of the infrared detecting module 14 is disposed in the second groove 128. The outline of the first groove 127 and the second groove 128 is approximately formed as rectangles, but embodiments are not limited thereto.

In this embodiment, the outer periphery portion 129 is protruded around the surface of the second region 1212; that is, the outer periphery portion 129 is extended and protruded from the periphery of the surface of the second region 1212. Based on this, by utilizing the soft structure, the ear cushion 11 is applied to enclose the outer periphery portion 129, thereby allowing the ear cushion 11 to be assembled with the speaker protecting cover 12.

Whether the infrared earphone 1 is attaching with the ear portion 21 of the user 2, is determined according to the positional relationship between the infrared detecting module 14 and the ear portion 21 of the user 2, thereby determining turning the infrared earphone 1 on or off, so that the infrared earphone 1 can be automatically activated or muted. The operation is described as follows.

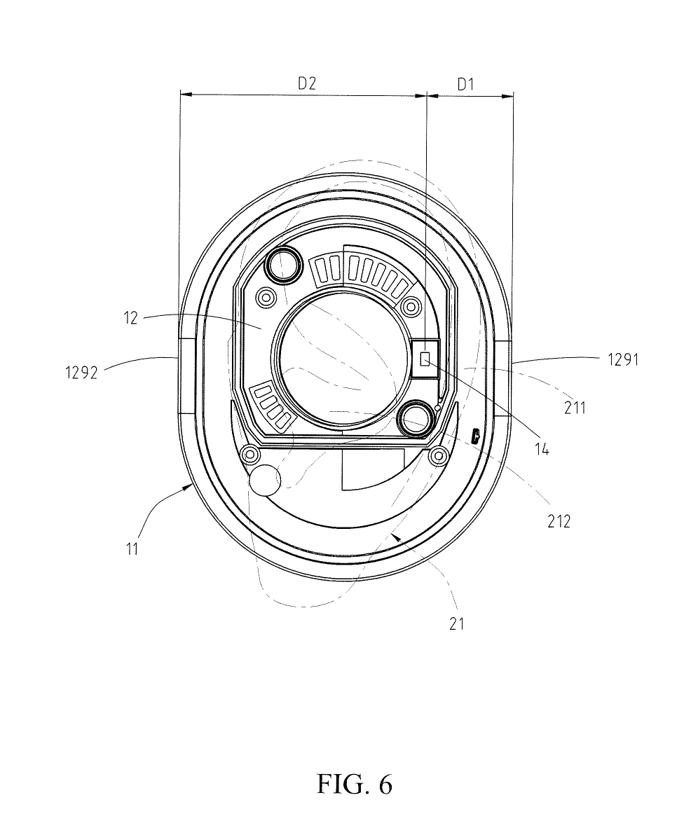

Please refer to FIG. 6, which is a schematic view for showing the speaker protecting cover 12 is worn on the ear portion 21 of the user 2, and please also refer to FIG. 5. It is understood that in order to clearly explicit the positional relationship between the infrared detecting module 14 and the ear portion 21 of the user 2, the ear cushion 11 is omitted in FIG. 6; only the speaker protecting cover 12 and parts of the components are illustrated, and dash lines are applied to illustrate the ear portion 21 of the user 2.

The ear portion 21 of the user 2 includes a cochlea 211 and an ear canal 212. When the infrared earphone 1 is worn on the ear portion 21 of the user 2, the position of the speaker 13 corresponds to the position of the ear canal 212. Accordingly, the user 2 receives clear sounds from the infrared earphone 1 without being disturbed by surrounding noises, thereby improving the acoustic output quality provided by the infrared earphone 1.

Furthermore, when the infrared earphone 1 is worn on the ear portion 21 of the user 2, the slot 125 and the infrared detecting module 14 therein are adjacent to the cochlea 211.

In detail, the outer periphery portion 129 includes a first lateral surface 1291 and a second lateral surface 1292 opposite to the first lateral surface 1291. The first lateral surface 1291 and the second lateral surface 1292 are extended and protruded from the periphery of the surface of the second region 1212. A first distance Dl defined between the infrared detecting module 14 and the first lateral surface 1291 is smaller than a second distance D2 defined between the infrared detecting module 14 and the second lateral surface 1292. Based on this, when the infrared earphone 1 is worn on the ear portion 21 of the user 2, the first lateral surface 1291 is adjacent to the cochlea 211, and the second lateral surface 1292 is distant from the cochlea 211. Therefore, the slot 125 and the infrared detecting module 14 are configured to be adjacent to the cochlea 211 of the ear portion 21 of the user 2.

In detail, the ratio of the first distance D1 and the second distance D2 is 1:3, but embodiments are not limited thereto; in some embodiments, the position of the infrared detecting module 14 can be as closer to the cochlea 211 as possible. That is, upon the user wears on or takes off the infrared earphone 1, the speaker protecting cover 12 contacts with the cochlea 211 of the user 2. Accordingly, in this embodiment, the infrared detecting module 14 is disposed adjacent to the cochlea 211 of the user 2 to ensure the detecting distance of the infrared detecting module 14 is proper, thereby improving the precision of the detection of the infrared detecting module 14.

The operation of the infrared detecting module 14 is described as follows.

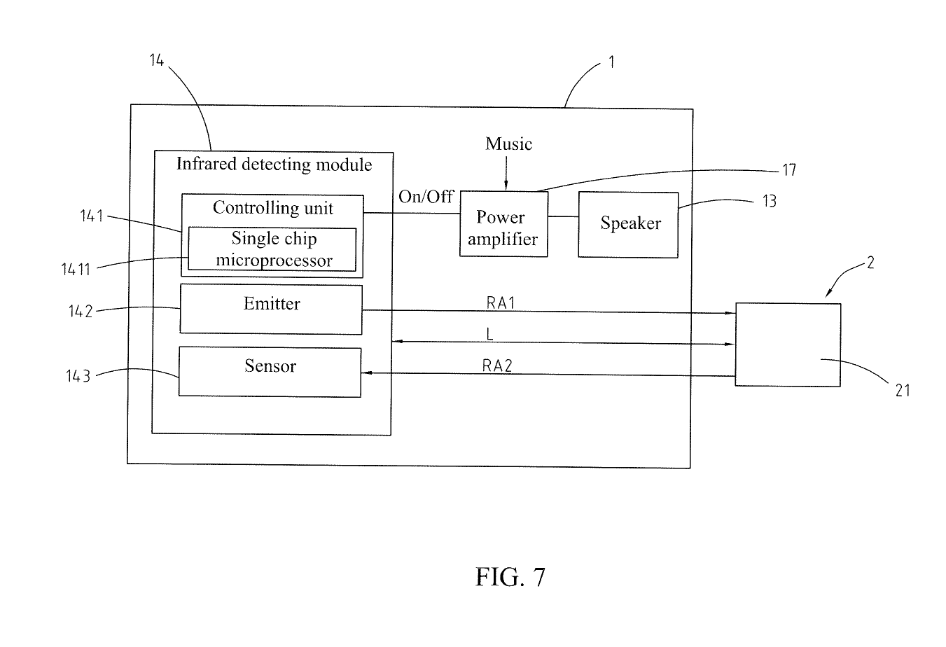

Please refer to FIG. 7, which is a block diagram showing the infrared earphone 1 and the infrared detecting module 14 thereof of the first embodiment, and please also refer to FIG. 6; in which the infrared detecting module 14 includes a controlling unit 141 coupled to the speaker 13 via a power amplifier 17. A reflection distance L is defined between the infrared detecting module 14 and the cochlea 211 of the ear portion 21 of the user 2. The controlling unit 141 generates an infrared reflection value according to the reflection distance L, so that the controlling unit turns on or off the power amplifier 17 according to the infrared reflection value. When the controlling unit 141 turns off the power amplifier 17, the speaker 13 does not play music, while when the controlling unit 141 turns on the power amplifier 17, the speaker 13 can play music.

Based on this, the infrared detecting module 14 determines whether the infrared earphone 1 is worn on the user 2 or not according to the infrared reflection value; and, the infrared detecting module 14 determines to turn on or turn off the infrared earphone 1 according to the infrared reflection value.

In detail, the controlling unit 141 includes a single chip microprocessor 1411. The infrared detecting module 14 includes an emitter 142 and a sensor 143. The emitter 142 emits a first infrared wave RA1 to the ear portion 21 of the user 2. The sensor 143 receives a second infrared wave RA2 reflected by the ear portion 21 of the user 2. The single chip microprocessor 1411 calculates the infrared reflection value according to the second infrared wave RA2 reflected by the ear portion 21 of the user 2. The reflection distance L is inversely proportional to the infrared reflection value.

Relationships between the infrared reflection value and the reflection distance L in different conditions are described as follows.

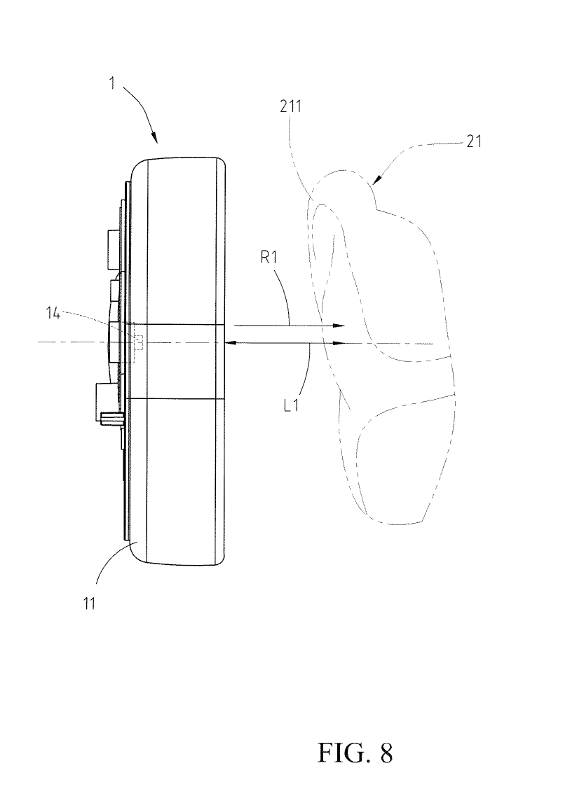

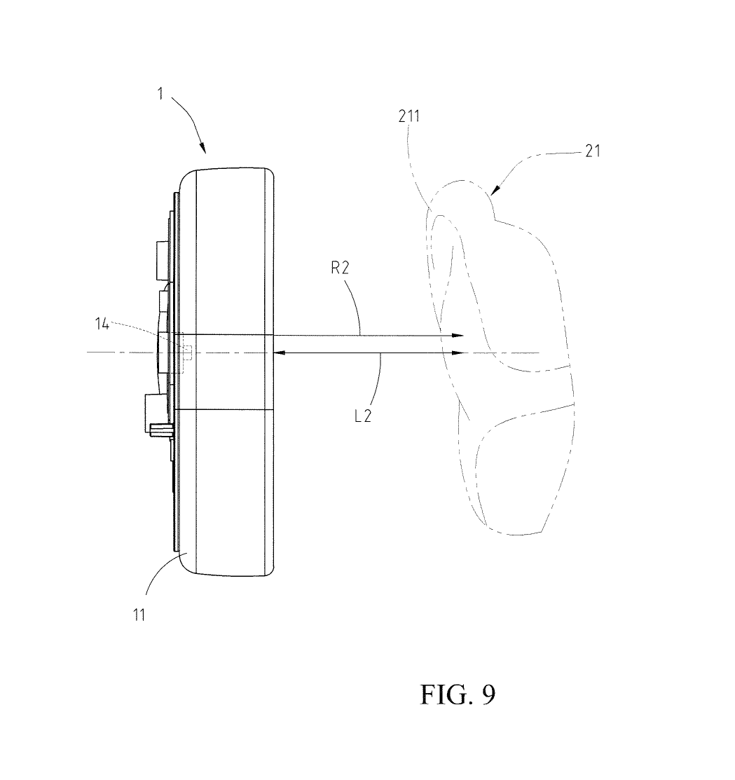

Please refer to FIG. 8 and FIG. 9, in which FIG. 8 is a schematic view showing the infrared earphone 1 is worn on the user 2 and FIG. 9 is a schematic view showing the infrared earphone 1 is not worn on the user 2. For the sake of clarity, the ear cushion 11 is omitted in FIG. 8 and FIG. 9.

As shown in FIG. 8, when the infrared earphone 1 is worn on the ear portion 21 of the user 2, the reflection distance between the infrared detecting module 14 and the cochlea 211 is L1, the infrared reflection value is defined as a first value R1, and the controlling unit 141 turns the power amplifier 17 on.

It is understood that in FIG. 8, the infrared detecting module 14 is very close to the cochlea 211; however, in order to clearly illustrate the positional relationship between the components, the reflection distance L1 between the infrared detecting module 14 and the cochlea 211 is enlarged.

As shown in FIG. 9, when the infrared earphone 1 is not worn on the ear portion 21 of the user 2, the reflection distance between the infrared detecting module 14 and the cochlea 211 is L2, the infrared reflection value is defined as a second value R2, and the controlling unit 141 turns the speaker 13 off.

In the two conditions provided above, the first value R1 is larger than the second value R2, and L1 is smaller than L2. For example, when the infrared earphone 1 is worn on the ear portion 21 of the user 2, the reflection distance L1 between the infrared detecting module 14 and the cochlea 211 is a minimum value. Therefore, the controlling unit 141 sets the infrared reflection value R1 generated in this reflection distance L1 as a maximum value to turn on the power amplifier 17, but embodiments are not limited thereto; in some embodiments, the reflection distance L1 between the infrared detecting module 14 and the cochlea 211 is small enough, so that the voltage generated by the infrared reflection value R1 is sufficient for turning on the power amplifier 17.

Conversely, when the infrared earphone 1 is not worn on the ear portion 21 of the user 2, the reflection distance L2 between the infrared detecting module 14 and the cochlea 211 is larger than the reflection distance L1, so that the infrared reflection value R2 detected by the infrared detecting module 14 is rather smaller than the infrared reflection value R1, and a relatively lower voltage, which cannot turn on the power amplifier 17 is generated, resulting in the infrared earphone 1 being turned off automatically. Accordingly, in the case of the infrared earphone 1 being taken off from the user 2, the electricity of the infrared earphone 1 is not wasted when the user 2 forgets to turn off the infrared earphone 1, resulting in the electricity of the infrared earphone 1 being conserved.

Furthermore, as shown in FIG. 8 and FIG. 9, during detachment of the infrared earphone 1 from the ear portion 21 of the user 2, the reflection distance L is gradually increased. Since the infrared reflection value is inversely proportional to the reflection distance L, along with the increasing of the reflection distance L, the infrared reflection value is reduced gradually. Accordingly, along with the gradually reduction of the infrared reflection value, the voltage generated by the controlling unit 141 is reduced gradually, thereby the volume of the speaker 13 being gradually reduced until the power amplifier 17 is turned off, so that the infrared earphone 1 is turned off automatically.

On the other hand, during attaching the infrared earphone 1 to the ear portion 21 of the user 2, along with the gradually reduction of the reflection distance L, the infrared reflection value R is gradually increased, and the controlling unit 141 gradually increases the volume of the music or the sound output by the speaker 13.

Based on the above, while the user 2 is wearing or taking off the infrared earphone 1, not only can the power amplifier 17 be turned on or off automatically, but the volume of the music or the sound output by the speaker 13 can also be adjusted according to the distance between the infrared detecting module 14 and the cochlea 211.

Additionally, as shown in FIG. 9, when the infrared earphone 1 is muted, the user 2 can turn on the power amplifier 17 by wearing the infrared earphone 1 again. Consequently, according to the present invention, the electricity of the infrared earphone 1 is not wasted when the infrared earphone 1 is not worn on the user 2.

It is understood that, the lengths of the reflection distances L1 and L2 illustrated in FIG. 8 and FIG. 9 are merely for example, and can be adjusted according to the practical conditions.

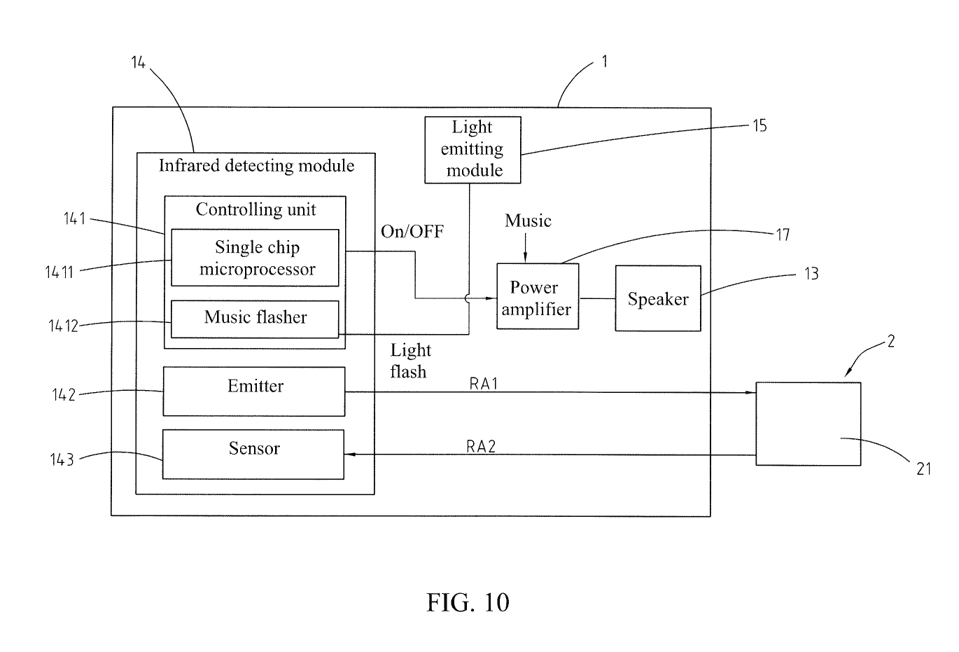

Please refer to FIG. 10, which is a block diagram showing an infrared earphone 1 of a second embodiment and an infrared detecting module 14 thereof. The structure of the infrared earphone 1 of the second embodiment is approximately the same as that of the first embodiment, except that in the second embodiment, the infrared earphone 1 further includes a light emitting module 15 provided for emitting light. Furthermore, the position of the light emitting module 15 is determined according users requirements, embodiments are not limited thereto.

The light emitting module 15 is coupled to the controlling unit 141. The controlling unit 141 drives the light emitting module 15 to be turned on or turned off according to the infrared reflection value. For example, when the infrared earphone 1 is worn on the ear portion 21 of the user 2, as shown in FIG. 8, the reflection distance L1 between the infrared detecting module 14 and the cochlea 211 is a minimum value. Therefore, the controlling unit 141 sets the infrared reflection value R1 generated in this reflection distance L1 as a maximum value, thereby generating enough voltage for turning the light emitting module 15 on, but embodiments are not limited thereto; in some embodiments, the reflection distance L1 between the infrared detecting module 14 and the cochlea 211 is small enough so that the voltage generated by the infrared reflection value R1 is sufficient for turning on the light emitting module 14.

Conversely, as shown in FIG. 9, when the infrared earphone 1 is not worn on the ear portion 21 of the user 2, the reflection distance L2 between the infrared detecting module 14 and the cochlea 211 is larger than the reflection distance L1, so that the infrared reflection value R2 is rather smaller than the infrared reflection value R1, and a relatively lower voltage, which cannot turn on the light emitting module 15 is generated, thereby the light emitting module 15 being turned off. Accordingly, in the case of the user 2 taking off the infrared earphone 1, the electricity of the light emitting module 15 is not wasted when the user 2 forgets to turn off the light emitting module 15, ensuring the electricity is conserved.

In some implementation aspects, the controlling unit 141 includes a musical flasher 1412. The musical flasher 1412 controls the light emitting module 15 to flash according to the volume of the music or the sound output by the speaker 13; that is, the musical flasher 1412 controls the luminescence of the light emitting module 15 according to the volume of the music or the sound output by the speaker 13. For example, when the infrared earphone I is worn on the user 2, as shown in FIG. 8, the infrared reflection value R1 becomes maximized, thereby the controlling unit 141 turning on the power amplifier 17 and the light emitting module 15; meanwhile, the musical flasher 1412 controls the light emitting module 15 to flash according to the volume of the music or the sound output by the speaker 13, but embodiments are not limited thereto; in some embodiments, the reflection distance L1 between the infrared detecting module 14 and the cochlea 211 is small enough to generate the infrared reflection value R1 thus enabling the musical flasher 1412 to control the light emitting module 15 to flash.

Conversely, when the infrared earphone 1 is not worn on the user 2, as shown in FIG. 9, the infrared reflection value R2 is rather lower, such that the controlling unit 141 can turn off the power amplifier 17, reduce the volume of the music or the sound output by the speaker 13 or reduce the brightness of the light emitting module 15. Based on this, the musical flasher 1412 gradually adjusts the luminescence of the light emitting module 15 until the light emitting module 15 is turned off.

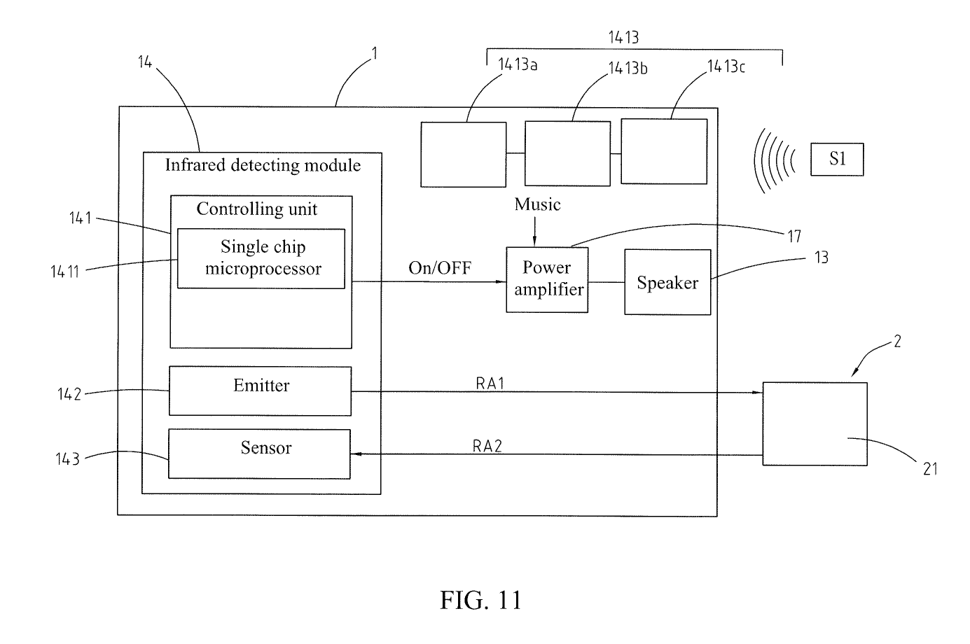

Please refer to FIG. 11, which is a block diagram showing an infrared earphone 1 of a third embodiment and an infrared detecting module 14 thereof. The structure of the infrared earphone 1 of the third embodiment is approximately the same as that of the first embodiment, except that in the third embodiment, the infrared earphone 1 further includes an active noise reducer 1413, the active noise reducer 1413 includes a phase converter 1413a, a filter 1413b and a microphone 1413c.

The active noise reducer 1413 can be embodied by an active noise reducing circuit or an active noise reducing chip. Firstly, the microphone 1413c of the active noise reducer 1413 receives the surrounding noise signal S1 (that is, the noise from the surrounding); and then, the surrounding noise signal S1 is delivered to the filter 1413b (for example, the filter 1413b can be a high-pass filter, a low-pass filter, a notch filter or so forth; in this embodiment, the filter 1413b is a composite filter of low-pass and notch filters for passing the low frequency signals without echoes) to remove parts of the surrounding noise signal S1 corresponding to the frequency bands removed by the filter 1413b; thereafter, the filtered surrounding noise signal is further delivered to the phase converter 1413a, so that the filtered surrounding noise signal is phase-shifted by 180 degrees to generate a phase-shifted, filtered surrounding noise signal (processed surrounding noise signal); then, the phase-shifted, filtered surrounding noise signal is delivered to the power amplifier 17 to combine with the music signals (or sound signals). Therefore, when the infrared earphone 1 plays music, the music signals and the phase-shifted, filtered surrounding noise signal are outputted by the speaker 13, and the phase-shifted, filtered surrounding noise signal is combined with the surrounding noise signal S1. Based on this, the noise components in the surrounding noise signal S1 can be significantly reduced or eliminated by combining with the phase-shifted, filtered surrounding noise signal which has the same frequency but opposite phase respect to the surrounding noise signal S1.

Accordingly, the active noise reducer 1413 generates the phase-shifted, filtered surrounding noise signal according to the infrared reflection value and sends the phase-shifted, filtered surrounding noise signal to the power amplifier 17. For example, when the infrared earphone 1 is worn on the user 2, as shown in FIG. 8, the infrared reflection value R1 is maximized; thereby the phase-shifted, filtered surrounding noise signal generated by the active noise reducer 1413 is combined with the surrounding noise signal S1 and sufficiently reduces or eliminates the surrounding noise signal, thereby the user can listen with less noises or even without noises. It is understood that embodiments are not limited thereto; in some embodiments, the reflection distance L1 between the infrared detecting module 14 and the cochlear 211 is small enough to generate the infrared reflection value R1, so that the active noise reducer 1413, according to the infrared reflection value R1, generates the phase-shifted, filtered surrounding noise signal to reduce or to eliminate the surrounding noise signal S1.

On the contrary, as shown in FIG. 9, when the infrared earphone 1 is not worn on the user 2, the infrared reflection value R2 is rather lower and the intensity of the phase-shifted, filtered surrounding noise signal generated by the active noise reducer 1413 is rather weaker. Accordingly, when the infrared earphone 1 is not worn on the user 2, the active noise reducer 1413 generates the phase-shifted, filtered surrounding acoustic signal with weak intensity or even cannot generate the phase-shifted, filtered surrounding noise signal, so that the electricity of the infrared earphone 1 is conserved.

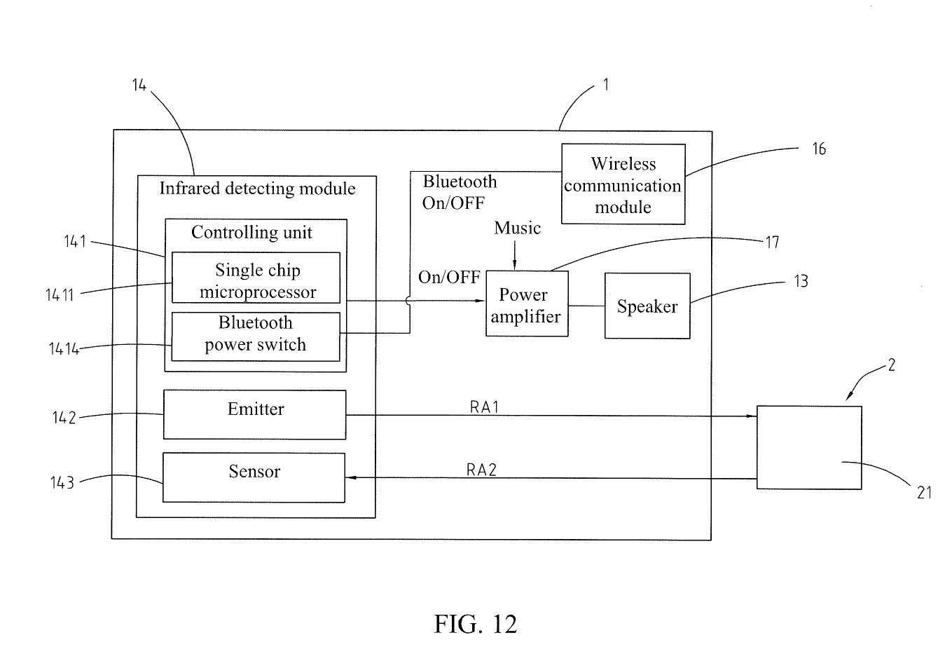

Please refer to FIG. 12, which is a block diagram showing an infrared earphone 1 of a fourth embodiment and an infrared detecting module 14 thereof. The structure of the infrared earphone 1 of the fourth embodiment is approximately the same as that of the first embodiment, except that in the fourth embodiment, the infrared earphone 1 is a Bluetooth infrared earphone, and the controlling unit 141 of the Bluetooth infrared earphone includes a Bluetooth power switch 1414.

The Bluetooth power switch 1414 controls a wireless communication module 16 (for example, a Bluetooth or a Wi-fi) of the infrared earphone 1 to be turned on or turned off. In this embodiment, the Bluetooth power switch 1414 is a physical switch provided to the user to turn on or turn off the wireless communication module 16. Alternatively, the Bluetooth power switch 14 can turn on or turn off the power amplifier 17; in some implementation aspects, the Bluetooth power switch is provided to turn on or turn off the active noise reducer.

It is understood that, the aforementioned light emitting module 15, musical flasher 1412, active noise reducer 1413 and the Bluetooth power switch 1414 can be optionally combined with each other according to user requirements.

As described previously, the main body of the speaker protecting cover of the infrared earphone is divided into the first region and the second region; the slot is disposed at the first region, and the infrared detecting module is disposed in the slot. Therefore, the infrared detecting module detects the positional relationship between the infrared earphone and the user to generate the infrared reflection value, so that the infrared earphone is determined to be turned on or off according to the infrared reflection value. Consequently, when the infrared earphone is worn on the ear portion of the user, the infrared reflection value detected by the infrared detecting module is sufficient to drive the speaker, so that the infrared earphone is turned on automatically; on the contrary, when the infrared earphone is not worn on the ear portion of the user, the infrared reflection value detected by the infrared detecting module is insufficient to drive the speaker, so that the infrared earphone is turned off automatically.

Furthermore, the volume of the infrared earphone can be adjusted to be louder or quieter, according to the distance between the infrared earphone and the ear portion of the user. Therefore, according to the operations of the user, the distance between the infrared earphone and the user is varied; thereby the volume of the infrared earphone is adjusted according to user requirements.

Additionally, the infrared earphone of the disclosure further includes the light emitting module, the active noise reducer and the Bluetooth power switch for providing various functions. The aforementioned components can be activated or deactivated depending on the infrared reflection value. Accordingly, when the user takes the infrared earphone from the ear portion thereof, the light emitting module, the active noise reducer and the Bluetooth power switch is automatically turned off, thereby conserving the electricity.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An infrared earphone, configured to wear to an ear portion of a user, the ear portion comprises a cochlea, the infrared earphone comprising:
a speaker protecting cover, comprising:
a main body, comprising:
a first region; and
a second region, disposed at a periphery of the first region;
a recessed portion, disposed at the first region, an inner lateral plane of the recessed portion being lower than a surface of the second region; and
a slot, disposed at the inner lateral plane of the recessed portion;
a speaker, disposed at the first region and adjacent to the slot;
an infrared detecting module, disposed in the slot and coupled to the speaker, the infrared detecting module comprising a controlling unit coupled to the speaker via a power amplifier; and
an ear cushion, assembled to the speaker protecting cover, wherein a reflection distance is defined between the infrared detecting module and the cochlea of the ear portion, the controlling unit generates an infrared reflection value according to the reflection distance so as to turn on or turn off the power amplifier according to the infrared reflection value.

2. The infrared earphone according to claim 1, wherein the speaker protecting cover further comprises:
an assembling portion, disposed at the first region and being tilted respect to the recessed portion, wherein the speaker is disposed on the assembling portion; and
a plurality of acoustic output orifices, disposed at an periphery of the assembling portion.

3. The infrared earphone according to claim 2, wherein the speaker protecting cover further comprises:
a first groove, disposed on a surface of the recessed portion and adjacent to the assembling portion;
a second groove, disposed on the other surface of the recessed portion, the slot passing through the first groove and the second groove; and
a radio frequency member, disposed in the first groove.

4. The infrared earphone according to claim 1, wherein the speaker protecting cover further comprises:
an outer periphery portion, protruded around the surface of the second region, the outer periphery portion comprising a first lateral surface and a second lateral surface opposite to each other, a first distance defined between the infrared detecting module and the first lateral surface being smaller than a second distance defined between the infrared detecting module and the second lateral surface.

5. The infrared earphone according to claim 4, wherein a ratio of the first distance and the second distance is 1:3.

6. The infrared earphone according to claim 1, wherein the reflection distance is inversely proportional to the infrared reflection value.

7. The infrared earphone according to claim 1, wherein during detaching the infrared earphone from the ear portion of the user, the reflection distance is gradually increased while the infrared reflection value is gradually reduced, and the controlling unit gradually reduces the volume of the music or sound output by the speaker along with the gradual reduction of the infrared reflection value until the power amplifier is turned off.

8. The infrared earphone according to claim 1, wherein during attaching the infrared earphone to the ear portion of the user, the reflection distance is gradually decreased while the infrared reflection value is gradually increased, and the controlling unit gradually increases the volume of the music or sound output by the speaker along with the gradual increasing of the infrared reflection value.

9. The infrared earphone according to claim 1, further comprising:
a light emitting module, coupled to the controlling unit, the controlling unit driving the light emitting module to be turned on or turned off according to the infrared reflection value.

10. The infrared earphone according to claim 9, wherein the controlling unit comprises:
a musical flasher, controlling the light emitting module to flash according to the volume of the music or sound output by the speaker.

11. The infrared earphone according to claim 1, wherein the infrared earphone is a Bluetooth infrared earphone, the Bluetooth infrared earphone comprises a wireless communication module, the controlling unit comprises a Bluetooth power switch, the Bluetooth power switch turns on or turns off the wireless communication module.

12. The infrared earphone according to claim 1, wherein the controlling unit comprises:
an active noise reducer, generating a processed surrounding noise signal according to a surrounding noise signal out of the infrared earphone, the processed surrounding noise signal being sent to the amplifier.
